(19) United States
(12) Patent Application Publication
(10) Pub. No.: US 2020/0008601 A1
(43) Pub. Date: Jan. 9, 2020

(54) Multifunctional Grilling and Cooking Pot

(71) Applicant: ZHONGSHAN FENGYE ELECTRICAL APPLIANCE CO., LTD., Zhongshan (CN)

(72) Inventor: Xiaoyang CAO, Zhongshan (CN)

(73) Assignee: ZHONGSHAN FENGYE ELECTRICAL APPLIANCE CO., LTD., Zhongshan (CN)

(21) Appl. No.: 16/504,347

(22) Filed: Jul. 8, 2019

(30) Foreign Application Priority Data
Jul. 6, 2018 (CN) 201810738567.7

(51) Int. Cl. A47J 27/12; A47J 27/00; A47J 27/02; A47J 37/06; A47J 37/04; A47J 36/32

(52) U.S. Cl. CPC A47J 27/12; A47J 27/004; A47J 27/02; A47J 36/32; A47J 37/0664; A47J 37/041; A47J 37/0629

(57) ABSTRACT

An integrated multifunctional grill and hot pot. A grill cavity and a hot pot cavity are provided inside a housing. A grill pan is detachably placed on an opening at an upper end of the grill cavity. A side of the housing is inserted with a skewer component. A cavity wall of the grill cavity is fixedly mounted with a first heating element between the grill pan and the skewer component. The skewer component includes a gridiron. A front end of the gridiron is provided with a handle. The skewers are connected to a rotating mechanism driving the skewers to rotate relative to the gridiron. The hot pot is detachably placed at an upper end of the hot pot cavity. A second heating element located at a lower end of the hot pot is provided inside the hot pot cavity. The hot pot is heated by the second heating element.

### CROSS REFERENCE TO THE RELATED APPLICATIONS

This application is based upon and claims priority to Chinese Patent Application No. 201810738567.7, filed on Jul. 6, 2018, the entire contents of which are incorporated herein by reference.

### TECHNICAL FIELD

The present invention relates to a kitchen appliance and in particular to an integrated multifunctional grill and hot pot.

### BACKGROUND

The electric grill commonly available on the market generally has a structure including a grill pan and a housing with a heating element. The grill pan is detachably placed on an opening at an upper end of the housing and a lower surface of the grill pan abuts against the heating element. After the heating element is energized, users can directly grill or fry various food on the grill pan, such as meat, vegetables, and wheaten food. With the evolution of society and the improvement of living standards, eating habits and lifestyles of many young people are constantly changing. More and more people prefer to use an electric grill to grill food while enjoying various food cooked by other cookers. However, due to factors such as volume and the structure of the grill, the electric grill does not have the function of a hot pot, a cooker or a barbecue. Therefore, the user needs to find another type of cooker, such as using an electric hot pot or a gridiron for barbecuing. The electric grill has difficulties meeting the users' requirements for a multifunctional cooker. Therefore, the present invention has solved this problem by designing an integrated multifunctional grill and hot pot.

### SUMMARY

To solve the above problem, the present invention provides an integrated multifunctional grill and hot pot capable of grilling, barbecuing, making a hot pot, and cooking at the same time, so as to meet the users' requirements for a multifunctional cooker.

To this end, the present invention provides the following technical solutions.

An integrated multifunctional grill and hot pot includes a housing and a grill pan, wherein the housing includes an accommodating space, a baffle board is provided inside the housing to divide the accommodating space into a grill cavity and a hot pot cavity. The grill pan can be detachably placed on an opening at an upper end of the grill cavity. A side of the housing is provided with an insertion opening interconnected to the grill cavity, and the insertion opening is inserted with a skewer component. A cavity wall of the grill cavity is fixedly mounted with a first heating element configured between the grill pan and the skewer component. The skewer component includes a gridiron and skewers placed on the gridiron. A front end of the gridiron is provided with a handle. The skewers are connected to a rotating mechanism for driving the skewers to rotate relative to the gridiron. An upper end of the hot pot cavity is detachably provided with a hot pot. The hot pot cavity is provided with a second heating element located at a lower end of the hot pot. A control circuit is further provided inside the housing. The first heating element, the second heating element and the rotating mechanism are electrically connected to the control circuit, respectively.

As a preferred embodiment, further limitations are as follows. The rotating mechanism includes a driving motor provided in the housing, a driving gear connected to an output shaft of the driving motor and a driven gear provided at one end of the gridiron and engaged with the driving gear, wherein the driven gear is provided with a first sprocket. The driven gear drives the first sprocket to rotate synchronously. The other end of the gridiron is provided with a second sprocket corresponding to the first sprocket, and the first sprocket and the second sprocket are in an engaged transmission through a transmission chain. Each of the skewers is provided with a third sprocket engaged with the transmission chain and driving the skewer to rotate relative to the gridiron through the transmission chain.

As a preferred embodiment, further limitations are as follows. A front end of the driven gear is provided with a connecting shaft. An outer side surface of the connecting shaft protrudes outward to form a flat key. The first sprocket is provided with a connecting hole matched with the connecting shaft. The connecting hole is provided with a keyway engaged with the flat key in a keyed joint. After assembly, the first sprocket and the driven gear synchronously rotate.

As a preferred embodiment, further limitations are as follows. The front end of the gridiron is provided with a transmission cavity accommodating a transmission component. The front end of the gridiron is further provided with longitudinal grooves and transverse grooves with openings facing upward and interconnected to each other. The transverse groove is connected to the transmission cavity. A rear end of the gridiron is provided with first notches with openings facing upward and corresponding to the longitudinal grooves. During use, the front end of the skewer is put in the first notch. The rear end of the skewer is put in the longitudinal groove. A lower end of the third sprocket penetrates through the transverse groove to be engaged with the transmission chain. A width of the transverse groove is larger than a diameter of the third sprocket. The rear end of the skewer is further provided with a handle.

As a preferred embodiment, further limitations are as follows. The gridiron is integrally formed into one piece. The gridiron is provided with a base board. An edge of a rear end of the base board is bent upward to form a rear board. The first notches are provided on the rear board. An edge of a front end of the base board is bent upward to form a front board. An upper end of the front board is provided with a rolled edge. The longitudinal groove and the transverse groove are respectively provided on the rolled edge. The front end of the front board is provided with a decorative cover board. The transmission cavity is formed between the front board and the decorative cover board. An upper end of the decorative cover board is provided with second notches corresponding to the longitudinal grooves. The handle is arranged on a front end of the decorative cover board.

As a preferred embodiment, further limitations are as follows. The rolled edge includes a transverse portion and a longitudinal portion. The longitudinal portion tightly abuts against a front end surface of the decorative cover board. The transverse groove is provided on the transverse portion. The longitudinal portion is provided with a third notch corresponding to the second notch.

As a preferred embodiment, further limitations are as follows. A lower end of the hot pot is provided with a heat conducting portion. A lower end of the heat conducting portion is concave inward to form a heat conducting groove for accommodating the second heating element. After assembly, the second heating element abuts against the heat conducting groove.

As a preferred embodiment, a further limitation is as follows. An upper end of the hot pot is covered with a hot pot lid.

As a preferred embodiment, further limitations are as follows. A side of the grill pan is provided with a decorative portion covering an edge of an upper end of the hot pot cavity. The decorative portion is provided with a hot pot opening for inserting the hot pot. After assembly, an edge of the hot pot abuts against the decorative portion.

As a preferred embodiment, a further limitation is as follows. Two sides of the upper end of the housing which respectively are concave inward and an edge of the grill pan form a handle groove for inserting fingers.

The present invention has the following advantages.

1. The grill pan of the present invention can be detachably placed on the opening at the upper end of the grill cavity. The side end of the housing is inserted with the skewer component, and the cavity wall of the grill cavity is fixedly mounted with the first heating element between the grill pan and the skewer component. Not only can a barbecue function be realized, but also a sufficient use of heat generated by the first heating component is made, so as to improve the energy utilization rate.

2. The skewer component includes the gridiron and the skewers mounted on the gridiron. The skewers are connected to the rotating mechanism for driving the skewers to rotate relative to the gridiron, therefore obtaining an automatic rotary barbecue with a high intelligence.

3. The hot pot is detachably placed on the upper end of the hot pot cavity and the hot pot cavity is provided with a second heating element located at the lower end of the hot pot. The hot pot is heated by the second heating element in order to heat the hot pot or cook food. Various cooking functions are integrated into one pot, so as to meet the users' requirements for multifunctional cookers.

4. The user can individually control working states and temperatures of the first heating element and the second heating element as needed. The housing includes the grill cavity and the hot pot cavity, through which heat generated by the first heating element and the second heating element respectively are isolated and preserved, thus reducing heat loss and improving thermal efficiency.

### BRIEF DESCRIPTION OF THE DRAWINGS

FIG. 1 is a structural schematic diagram of the present invention;

FIG. 2 is an exploded schematic view of the present invention;

FIG. 3 is an exploded schematic view of a skewer component;

FIG. 4 is an enlarged schematic view showing the portion A in FIG. 2;

FIG. 5 is an enlarged schematic view showing the portion B in FIG. 2;

FIG. 6 is an enlarged schematic view showing the portion C in FIG. 3;

FIG. 7 is a structural schematic diagram of a driven gear;

FIG. 8 is a structural schematic diagram of a first sprocket;

FIG. 9 is a structural schematic diagram of a skewer; and

FIG. 10 is a structural schematic diagram of a hot pot.

### DETAILED DESCRIPTION OF THE EMBODIMENTS

The present invention is described in detail hereinafter with reference to the drawings and specific embodiments.

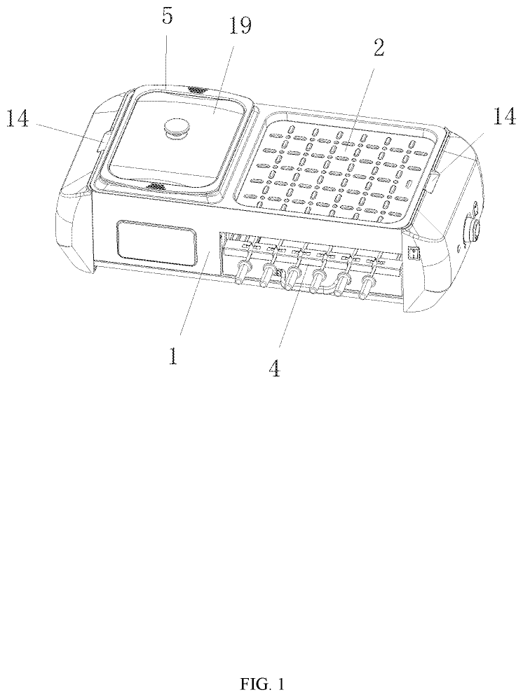

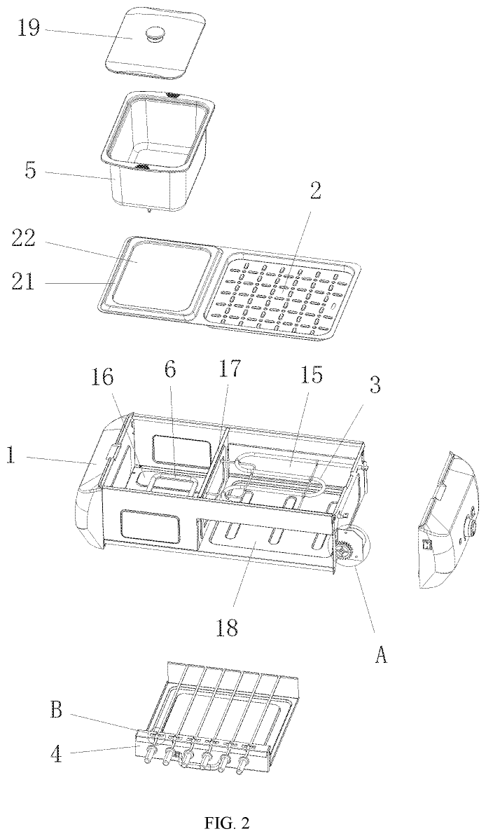

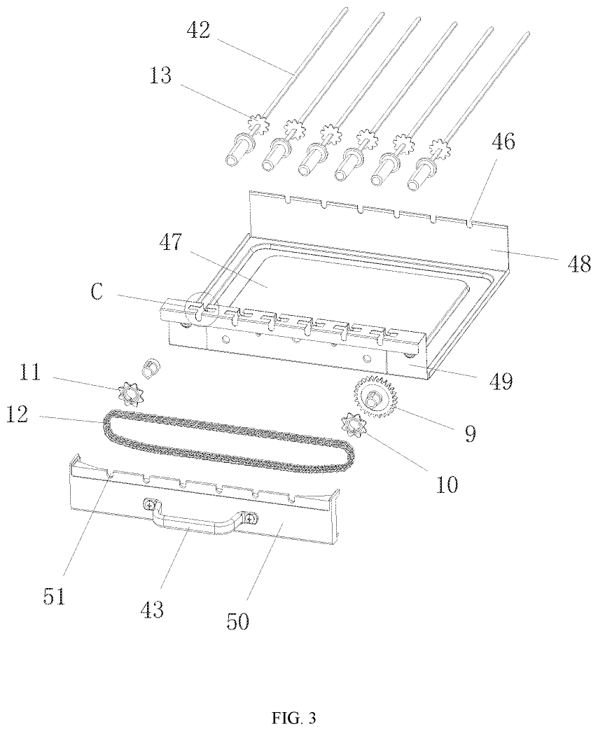

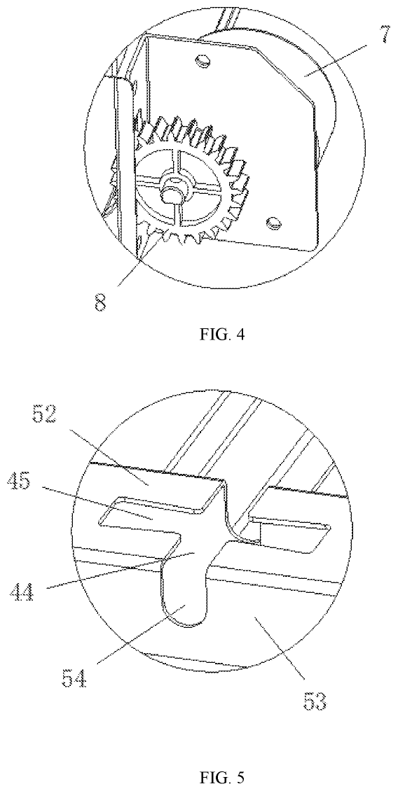

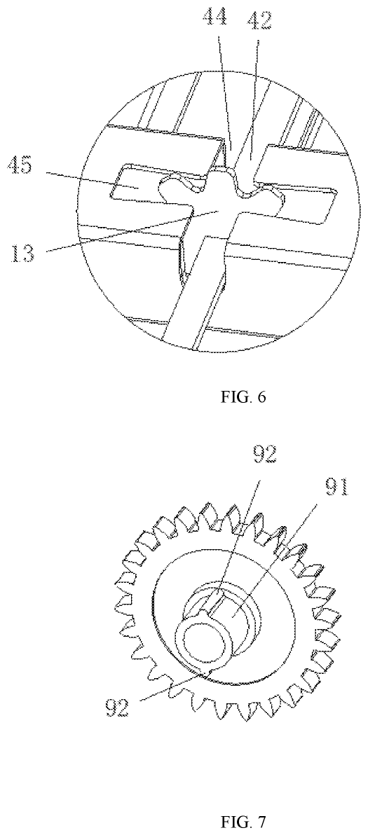

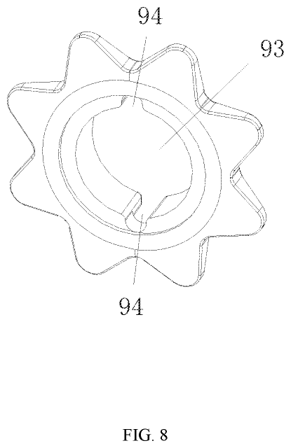

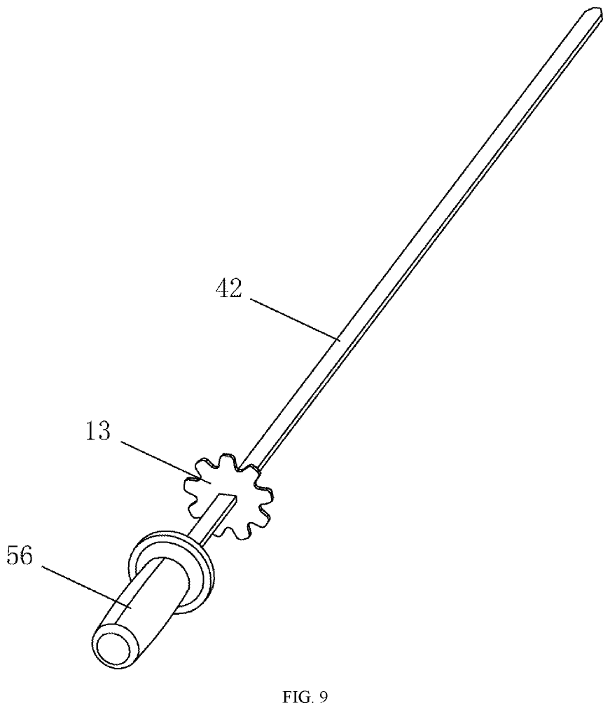

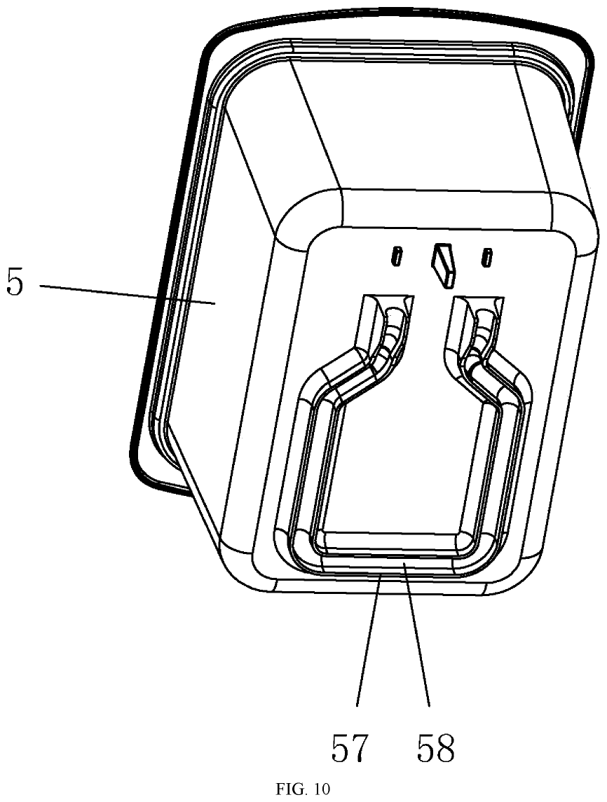

As shown in FIG. 1-FIG. 10, an integrated multifunctional grill and hot pot includes the housing 1 and the grill pan 2. The housing 1 includes an accommodating space. The baffle board 17 is provided inside the housing 1 to divide the accommodating into the grill cavity 15 and the hot pot cavity 16. The grill pan 2 can be detachably placed on an opening at an upper end of the grill cavity 15, so that the grill pan 2 can be conveniently dismounted for cleaning. A side of the housing is provided with the insertion opening 18 interconnected to the grill cavity 15. The insertion opening 18 is inserted with the skewer component 4. A cavity wall of the grill cavity 15 is fixedly mounted with the first heating element 3 configured between the grill pan 2 and the skewer component 4, thus grilling and barbecuing can be performed at the same time and heat generated by the first heating element can be fully used, thereby improving the energy utilization rate. The skewer component 4 includes the gridiron 41 and the skewers 42 placed on the gridiron 42. A front end of the gridiron 41 is provided with the handle 43 for conveniently pushing in or pulling out the skewer component 4. The skewers 42 are connected to a rotating mechanism for driving the skewers to rotate relative to the gridiron 41, thus obtaining an automatic rotary barbecue with a high intelligence. The hot pot 5 is detachably placed on an upper end of the hot pot cavity 16. The second heating element 6 is provided in the hot pot cavity 16 and located at a lower end of the hot pot 5. By heating the hot pot 5 with the second heating element 6, making a hot pot or cooking food can be realized, so as to integrate a variety of cooking functions into one pot and satisfy the users' requirements for the multifunctional cooker.

A control circuit is further provided inside the housing 1. The first heating element 3, the second heating element 6, and the rotating mechanism are electrically connected to the control circuit, respectively. A surface of the housing 1 is provided with a temperature controlled switch and a power switch, through which working states and temperatures of the first heating element and the second heating element can be individually controlled. Additionally, the baffle board 17 is provided inside the housing 1 to divide the accommodating space into the grill cavity, 15 and the hot pot cavity 16, through which the heat generated by the first heating element and the second heating element can be preserved, so as to reduce heat loss and improve thermal efficiency.

In the present embodiment, the rotating mechanism includes the driving motor 7 provided in the housing 1, the driving gear 8 connected to an output shaft of the driving motor 7, and the driven gear 9 provided at one end of the gridiron 41 and engaged with the driving gear 8. The driven gear 9 is provided with the first sprocket 10. The other end of the gridiron 41 is provided with the second sprocket 11 corresponding to the first sprocket 10. The driving motor 7 drives the driving gear 8 to rotate. The driven gear 9 drives the first sprocket 10 to rotate synchronously. The first sprocket 10 drives the second sprocket 11 to rotate through the transmission chain 12. Each of the skewers 42 is provided with the third sprocket 13 engaged with the transmission chain 12 and driving the skewer to rotate relative to the gridiron 41 through the transmission chain 12. The above structure is ingeniously designed. The uniform rotation of the skewers 42 is realized through a chain drive (the chain drive refers to transferring motion and power by engagement between the sprocket teeth and chain sections) to ensure the food to be heated is uniformly cooked/heated.

Further, a front end of the driven gear 9 is provided with the connecting shaft 91. An outer side surface of the connecting shaft 91 protrudes outward to form the flat key 92. The first sprocket 10 is provided with the connecting hole 93 matched with the connecting shaft 91. The connecting hole 93 is provided with the keyway 94 engaged with the flat key 92 in a keyed joint. After assembly, the first sprocket 10 and the driven gear 9 synchronously rotate, which is achieved through the engagement between the flat key 92 and the keyway 94.

In the present embodiment, the front end of the gridiron 41 is provided with the transmission cavity accommodating a transmission component. The front end of the gridiron 41 is further provided with the longitudinal grooves 44 and the transverse grooves 45 with openings facing upward and interconnected to each other. The transverse grooves 45 are connected to the transmission cavity. A rear end of the gridiron 41 is provided with the first notches 46 with openings facing upward and corresponding to the longitudinal grooves 44. Lower ends of the longitudinal grooves 44 and the notches 46 are rounded corners for facilitating the rotation of the skewers 42. During use, front ends of the skewers 42 are placed in the first notches 46. Rear ends of the skewers are placed in the longitudinal grooves 44. A lower end of the third sprocket 13 penetrates through the transverse groove 45 to be engaged with the transmission chain 12. A width of the transverse groove 45 is larger than a diameter of the third sprocket 13. The skewers 42 are driven to rotate by the transmission chain 12. The above-mentioned structure is simple. The rear end of the skewer 42 is further provided with the handle 56. The handle 56 may be made of a wood material or other thermal insulation materials for conveniently holding.

In the present embodiment, the gridiron 41 is formed by stamping and bending an integrated metal board. The gridiron 41 is provided with the base board 47. An edge of a rear end of the base board 47 is bent upward to form the rear board 48. The first notch 46 is provided on the rear board 48. An edge of a front end of the base board 47 is bent upward to form the front board 49, A front end of the front board is provided with a rolled edge. The longitudinal groove 44 and the transverse groove 45 are respectively provided on the rolled edge and the structure is simple. The front end of the front board 49 is provided with the decorative cover board 50. The transmission cavity is formed between the front board 49 and the decorative cover board 50. The decorative cover board 50 has a shielding effect on the rotating mechanism and makes the product look more attractive. An upper end of the decorative cover board 50 is provided with the second notches 51 corresponding to the longitudinal grooves 44. The front end of the decorative cover board 50 is provided with the handle 43. Further, the rolled edge includes the transverse portion 52 and the longitudinal portion 53. The longitudinal portion 53 tightly abuts against a front end surface of the decorative cover board 50. The transverse groove 45 is provided on the transverse portion 52. The longitudinal portion 53 is provided with the third notches 54 corresponding to the second notches 51 and the structure is simple.

In the present embodiment, a lower end of the hot pot 5 is provided with the heat conducting portion 57. A lower end of the heat conducting portion 57 is concave inward to form the heat conducting groove 58 capable of accommodating the second heating element 6. After assembly, the second heating element 6 abuts against the heat conducting groove 58. The second heating element 6 is wrapped by the heat conducting groove 58, so that the heat conduction efficiency is higher through a contact between the second heating element 6 and the heat conduction groove. An upper end of the hot pot 5 is covered with the hot pot lid 19. During use, the hot pot is covered with the hot pot lid 19, achieving heat preservation of the hot pot 5. A side of the grill pan 2 close to the hot pot cavity 16 is provided with the decorative portion 21 covering an edge of an upper end of the hot pot cavity 16, effectively shielding the structure inside the hot pot cavity 16 so as to make the product look more attractive. The decorative portion 21 is provided with the hot pot opening 22 for inserting the hot pot 5. After assembly, an edge of the hot pot 5 abuts against the decorative portion 21. Two sides of the upper end of the housing 1 which are respectively concave inward and an edge of the grill pan 2 form the handle groove 14 for inserting fingers. The above-mentioned structure is ingeniously designed for conveniently holding the grill pan 2 when cleaning.

What is claimed is:

1. An integrated multifunctional grill and hot pot, comprising a housing and a grill pan, wherein the housing comprises an accommodating space, a baffle board is provided inside the housing to divide the accommodating space into a grill cavity and a hot pot cavity, the grill pan is detachably placed on an opening at an upper end of the grill cavity; a side of the housing is provided with an insertion opening interconnected to the grill cavity, and the insertion opening is inserted with a skewer component, a cavity wall of the grill cavity is fixedly mounted with a first heating element between the grill pan and the skewer component; the skewer component comprises a gridiron and a plurality of skewers placed on the gridiron, a front end of the gridiron is provided with a first handle, the plurality of skewers are connected to a rotating mechanism for driving the plurality of skewers to rotate relative to the gridiron; a hot pot is detachably placed on an upper end of the hot pot cavity, a second heating element is provided in the hot pot cavity and located at a lower end of the hot pot, a control circuit is further provided inside the housing, the first heating element, the second heating element, and the rotating mechanism are electrically connected to the control circuit, respectively.

2. The integrated multifunctional grill and hot pot according to claim 1, wherein the rotating mechanism comprises a driving motor provided in the housing, a driving gear connected to an output shaft of the driving motor, and a driven gear provided at a first end of the gridiron and engaged with the driving gear, the driven gear is provided with a first sprocket, the driven gear drives the first sprocket to rotate synchronously, a second end of the gridiron is provided with a second sprocket corresponding to the first sprocket, the first sprocket and the second sprocket are in an engaged transmission through a transmission chain, and each skewer of the skewers is provided with a third sprocket engaged with the transmission chain and driving the each skewer to rotate relative to the gridiron through the transmission chain.

3. The integrated multifunctional grill and hot pot according to claim 2, wherein a front end of the driven gear is provided with a connecting shaft, an outer side surface of the connecting shaft protrudes outward to form a flat key, the first sprocket is provided with a connecting hole matched with the connecting shaft, the connecting hole is provided with a keyway engaged with the flat key in a keyed joint, the first sprocket and the driven gear synchronously rotate after assembly.

4. The integrated multifunctional grill and hot pot according to claim 3, wherein the front end of the gridiron is provided with a transmission cavity accommodating a transmission component, the front end of the gridiron is further provided with longitudinal grooves and transverse grooves, openings of the longitudinal grooves and transverse grooves face upward and the longitudinal grooves and transverse grooves are interconnected to each other, the transverse grooves are connected to the transmission cavity, a rear end of the gridiron is provided with first notches with openings facing upward and the first notches correspond to the longitudinal grooves during use, front ends of the plurality of skewers are placed in the first notches, rear ends of the plurality of skewers are placed in the longitudinal grooves, and a lower end of the third sprocket penetrates through one of the transverse grooves to be engaged with the transmission chain, a width each of the transverse grooves is larger than a diameter of the third sprocket, and each of the rear ends of the plurality of skewers is further provided with a second handle.

5. The integrated multifunctional grill and hot pot according to claim 4, wherein the gridiron is integrally formed into one piece, the gridiron is provided with a base board, an edge of a rear end of the base board is bent upward to form a rear board, the first notches are provided on the rear board, an edge of a front end of the base board is bent upward to form a front board, an upper end of the front board is provided with a rolled edge, the longitudinal grooves and the transverse grooves are respectively provided on the rolled edge, a front end of the front board is provided with a decorative cover board, the transmission cavity is formed between the front board and the decorative cover board, an upper end of the decorative cover board is provided with second notches corresponding to the longitudinal grooves, a front end of the decorative cover board is provided with the first handle.

6. The integrated multifunctional grill and hot pot according to claim 5, wherein the rolled edge comprises a transverse portion and a longitudinal portion, the longitudinal portion tightly abuts against the front end of the decorative cover board, the transverse grooves are provided on the transverse portion, the longitudinal portion is provided with third notches corresponding to the second notches.

7. The integrated multifunctional grill and hot pot according to claim 1, wherein the lower end of the hot pot is provided with a heat conducting portion, and a lower end of the heat conducting portion is concave inward to form a heat conducting groove for accommodating the second heating element, the second heating element abuts against the heat conducting groove after assembly.

8. The integrated multifunctional grill and hot pot according to claim 1, wherein the upper end of the hot pot is covered with a hot pot lid.

9. The integrated multifunctional grill and hot pot according to claim 1, wherein a side of the grill pan is provided with a decorative portion-covering an edge of the upper end of the hot pot cavity, and the decorative portion is provided with a hot pot opening for inserting the hot pot, an edge of the hot pot abuts against the decorative portion after assembly.

10. The integrated multifunctional grill and hot pot according to claim 9, wherein two sides of an upper end of the housing which are respectively concave inward and an edge of the grill pan form a handle groove for inserting fingers.

11. The integrated multifunctional grill and hot pot according to claim 2, wherein the lower end of the hot pot is provided with a heat conducting portion, and a lower end of the heat conducting portion is concave inward to form a heat conducting groove for accommodating the second heating element, the second heating element abuts against the heat conducting groove after assembly.

12. The integrated multifunctional grill and hot pot according to claim 3, wherein the lower end of the hot pot is provided with a heat conducting portion, and a lower end of the heat conducting portion is concave inward to form a heat conducting groove for accommodating the second heating element, the second heating element abuts against the heat conducting groove after assembly.

13. The integrated multifunctional grill and hot pot according to claim 4, wherein the lower end of the hot pot is provided with a heat conducting portion, and a lower end of the heat conducting portion is concave inward to form a heat conducting groove for accommodating the second heating element, the second heating element abuts against the heat conducting groove after assembly.

14. The integrated multifunctional grill and hot pot according to claim 5, wherein the lower end of the hot pot is provided with a heat conducting portion, and a lower end of the heat conducting portion is concave inward to form a heat conducting groove for accommodating the second heating element, the second heating element abuts against the heat conducting groove after assembly.

15. The integrated multifunctional grill and hot pot according to claim 6, wherein the lower end of the hot pot is provided with a heat conducting portion, and a lower end of the heat conducting portion is concave inward to form a heat conducting groove for accommodating the second heating element, the second heating element abuts against the heat conducting groove after assembly.

16. The integrated multifunctional grill and hot pot according to claim 2, wherein the upper end of the hot pot is covered with a hot pot lid.

17. The integrated multifunctional grill and hot pot according to claim 3, wherein the upper end of the hot pot is covered with a hot pot lid.

18. The integrated multifunctional grill and hot pot according to claim 4, wherein the upper end of the hot pot is covered with a hot pot lid.

19. The integrated multifunctional grill and hot pot according to claim 5, wherein the upper end of the hot pot is covered with a hot pot lid.

20. The integrated multifunctional grill and hot pot according to claim 6, wherein the upper end of the hot pot is covered with a hot pot lid.
